(19) United States
(12) Patent Application Publication
(10) Pub. No.: US 2003/0050180 A1
(43) Pub. Date: Mar. 13, 2003

(54) Thin board of sintered product and its manufacturing method

(75) Inventors: Haruki Takahashi, Tochigi-Ken (JP); Yoshio Maehara, Tochigi-Ken (JP)

Correspondence Address: BACON & THOMAS, PLLC, 625 SLATERS LANE, FOURTH FLOOR, ALEXANDRIA, VA, 22314

(73) Assignee: Cerabo Japan Ltd., Tochigi-Ken (JP)

(21) Appl. No.: 10/224,465

(22) Filed: Aug. 21, 2002

(30) Foreign Application Priority Data
Sep. 11, 2001 (JP) 2001-275457

(51) Int. Cl. C04B 33/00

(52) U.S. Cl. 501/141

(57) ABSTRACT

The present invention provides a large-scale thin board of sintered body (ceramic tile) with low water absorption and high frost-resistance. The manufacturing method comprises the steps: to prepare vitrifying ingredients such as talc, feldspar and porcelain stone, low wollastonite which is a needle crystal mineral, and plastic clay as main components, then mix fine particles of those materials, to compact it into a thin board with its needle crystals oriented uniformly in one preferred direction, and to burn it at temperature lower than that of crystal inversion of low wollastonite, in order to manufacture a highly frost-resistant large-scale thin ceramic board with water absorption of 3% or less in an excellent product condition. It is further preferable to utilize low wollastonite which has undergone grading of grains by mixing short-fiber type and long-fiber type.

### DETAILED DESCRIPTION OF THE INVENTION

1. Technical Field of the Invention

The present invention belongs to the technical field of the large-scale thin board of sintered product and its manufacturing method, the features of which are low water absorption of 3% or less, high frost-resistant, and possibility of being used in cold areas.

2. Prior Arts

Thin-board-type sintered products (pottery tiles) are manufactured as exterior finishing materials for architecture today, and such materials are usually exposed to the open air. Water expands when it freezes; therefore, if the water absorbed in a sintered product freezes in winter or other times, the sintered product may suffer from cracks or breakage in worse cases, which is the problem of frost damage. And the larger the size of a thin board of sintered product becomes, the more the frost damage.

On the other hand, researches on large-scale thin boards of sintered products have been done for a certain period of time already, and products of as large as 1 m(width)×1 m(length)×5 mm (thickness) have been launched on the market. Moreover, even more-than-3-meter-long products have been known if their width is narrower. However, it is true that the wider and the longer the thin board becomes, the more difficult the manufacturing process will be. One of the reasons for that is an influence of free silica (mostly quartz) included in feldspar used as a vitrifying component and clay used for forming. Probably, quartz has a high thermal expansion coefficient, which causes differences in the temperature inclination during burning and annealing processes of a large-scale thin board of sintered product, and this easily leads to internal warp and duntings. Moreover, it causes other problems of slowing down the burning speed and making the production efficiency extremely low. To avoid such problems, there could be a choice of using materials such as cordierite and petalite which would set the expansion coefficient lower, but it is not practical, because those materials are so expensive that the boards would not sell as mass-production products at reasonable market prices. And generally, those materials require high burning temperature of 1200° Celsius or more, which easily leads to deformation by softening and sets dimensional accuracy low, because of their shrinkage rate of 10% or more.

To solve the problem, Japanese Patent No.2998072 is known as a technology of overcoming fragility and improving elasticity of the board. The patent recommends to form a green ware body by making it uniformly contain β-CaO.SiO₂ (wollastonite, β-wollastonite), which is needle crystal mineral (fibrous crystal mineral) and also general pottery materials including talc and clay, with the needle crystal mineral oriented and aligned in one preferred direction, and to sinter it, so that elastic large-scale thin ceramic tiles (pottery boards) would be manufactured.

By the way, needle crystal mineral wallastonite is a low form which has been used in other various fields, and in the field of ceramics, it is widely utilized. In the case of making compounds porcelaneous, it is sintered at a high temperature of 1200° Celsius or more to obtain densification and low water absorption, and then the above-mentioned low form wollastonite inverts to high form (pseudo-wollastonite) around 1120˜1130° Celsius making the important needle crystal change. Therefore, although it loses the effect of the needle crystal and becomes porcelaneous making densification proceed and water absorption get lower, softening deformation as well as internal warp occur, which easily leads to cracks and breakages, and thus makes it difficult to manufacture large-scale ceramic tiles. For that reason, conventionally, the burning temperature has been set at 1100° Celsius or lower to manufacture large-scale thin ceramic tiles with the water absorption of approx. 10%, wherein frost damage cannot be avoided, but only products of such unsatisfactory quality are being made at present, and this is the problem which the present invension will solve.

### MEASURES TO SOLVE THE PROBLEM

Thus, in order to solve the above-mentioned problem, we earnestly studied and consequently completed the present invention, considering that if burnt at a lower temperature than the temperature where needle crystals of low wollastonite will be inverted, that the reaction will be controlled, and that the needle crystals of low wollastonite will remain unchanged, so that by utilizing vitrifying components, even if burnt at a lower temperature than the inversion temperature of needle crystals of low wollastonite, densifi-cation (acquirement of low water absorption) will be made possible preventing dunts, further that firing shrinkage rate will be less, and finally that we will be able to manufacture large-scale ceramic boards which can be cut, are machinable and highly frost-resistant.

The present invention is a thin board of sintered product featuring low water absorption, manufactured through containing principal ingredients such as talc, vitrifying components, low wollastonite which is needle crystal mineral, and plastic clay; compacting them into a thin board with the low wollastonite oriented and aligned uniformly in one preferred direction; and then burning it at a temperature lower than the crystal inversion temperature of low wollastonite.

The present invention is the manufacturing method of the thin board of sintered product featuring low water absorption, manufactured through containing principal ingredients such as talc, vitrifying components, low wollastonite which is needle crystal mineral, and plastic clay; mixing, kneading and compacting them into a thin board with the low wollastonite oriented and aligned uniformly in one preferred direction; and then burning it at a temperature lower than the crystal inversion temperature of low wollastonite.

By carrying out the above-mentioned method, a thin dense board of large-scale sintered body (ceramic tile) can be manufactured to have on excellent quality, showing the low wollastonite without crystal inversion, and low water absorption.

This product features low absorption of 3% or less, and hereby it is possible to make it a highly frost-resistant thin board of sintered body, which can be used outdoors in cold areas without any problems.

This one can be said to feature the composition of talc in an amount of approx 5˜30%, vitrifying components in an amount of approx. 10˜40%, low wollasonite in an amount of approx. 10˜40%, and plastic clay in an amount of approx. 20˜50% each by weight, and hereby it will be an excellent large-scale thin ceramic board.

Furthermore, hereinabove the low wollastonite features the fact that it is a mixture of long-fiber and short-fiber types, and by doing so, particle sizes of the low wollastonite will be well-balanced, more stabilized reaction will occur, and it will be possible to mass-produce large-scale thin ceramic boards in excellent quality with the water absorption of less than 3%.

### FORM OF CARRYING OUR THE INVENTION

To carry our the present invention, the combination is of four principle ingredients, namely talc, vitrifying components such as feldspar and other pottery stones, low wollastonite and plastic clay. Talc not only is to improve compactibility, but also is an essential for low-temperature fusion by an eutectic action with vitrifying components, which will be mentioned later, and its recomended amount is approx. 5˜30% by weight. Also, particle size 44 μm (micrometers) or less is recomendable, and the center of the particle size distribution should be approx. 5 μm. The later-mentioned experiment result clearly shows that without talc, the compactibility not only is poor, but also is difficult for eutectic action to occur. Therefore, in order to obtain densification, high temperature will be necessary, causing a problem of low wollastonite's crystal inversion. Or, on the contrary, if much talc is used, plasticity will be low and compactibility will be affected, because the talc contains only a little hydroxyl, and also non-crystalline silica generated in the reaction process tends to invert to cristobalite, which will tend to cause “duntings”; thus, it is not recommended.

Secondly, regarding vitrifying components such as feldspar and other pottery stones, their usages need to be controlled according to how much they contain alkaline ingredients (K₂O, Na₂O) and according to their particle sizes. And for the present invention, suitable are vitrifying components containing approx. 3% or more alkalis, and also components containing approx. 80% or more of particles whose sizes are at least approx. 44 μm or less, while the maximum particle size should be approx. 110 pm or less.

A suitable amount of the vitrifying components to be combined, considering mutual reaction with talc, is approx. 10˜40% by weight. The experiment sample to be mentioned later shows that if no vitrifying components are used, then a radical reaction between clay and low wollastonite occurs with the talc working as a mineralizer, easily leading to softening deformation, and when large-scale ceramic boards are made, no use of vitrifiers causes internal warp and becomes one of the primary factors of warpage. Also, if the combination quantity of vitrifying components is increased, the effect of vitrification will be so strong that softening deformation will occur, and the shape-maintaining effect of low wollastonite will not function, so that consequently, it will tend to be impossible to manufacture large-scale ceramic tiles.

When add some percent by weight of feldspar which contains alkalis of 10% or more total content of alkaline ingredients, such as the above-mentioned K₂O and Na₂O, as the experiment results to be mentioned later clearly show, it is possible to manufacture large-scale ceramic tiles at a lower burning temperature.

The low wollastoie is not only an essential ingredient to maintain the shape of large-scale thin ceramic boards, but also an indispensable supplying source of calcium in order to obtain anorthite, which is the objective reaction product. The bigger the particle sizes (fiber length, aspect ratio) are, the more surely the shape-maintaining effect will be expected, but if particle sizes are too big, the reactivity will decline by contraries, and therefore, an aspect ratio of 20 or less is suitable.

Furthermore, suitable combination quantity of low wollastonite is in the range of 10˜40% by weight, and the bigger the quantity becomes, the higher the temperature will be for densification, while reactivity will be so radical that manufacturing large-scale ceramic tiles will be difficult. Also, to decrease the burning temperature, it is recommended to combine less amount of low wollastonite, while from the viewpoint of preventing cracks and breakages and of maintaining the shape of product, it should be recommended to combine approx. 10% or more by weight of low wollastonite.

Last, regarding plastic clay, the more clay minerals it contains, the less quantity it should be combined, and thus combination quantity of approx. 20˜50% by weight is suitable. If the amount is less than 20% by weight; when a green ware body is compacted with the needle crystals of low wollastonite oriented in one preferred direction, it will be short of plasticity during the processes of extrusion and rolling, and compacting will be difficult. On the other hand, if the amount of plastic clay is over 50% by weight, there will be another problem that dehydration takes more time, decreasing productivity. And because combination amounts of other principle ingredients decrease, even if the compact is sintered at a lower temperature than the crystal inversion temperature of low wollastonite, another problem occurs that satisfying products cannot be obtained.

### EXPERIMENT SAMPLE 1

Next, an experiment sample is explained as follows: First, according the quantities (unit: percentage by weight) shown in the table of FIG. 1, we combined talc, Gunma feldspar and Murakami pottery stone as vitrifying components, long-fiber wollastonite (aspect ratio 20 or less, main fiber length 210 μm), and Motoyma-Kibushi clay as plastic clay each in fine particles; and after mixing and stirring the combined particles in a mixmuller for 15 minutes, we added to it 20% of water with the water weight included; and we kneaded it into a body. Then, we extruded it using a de-airing pug-mill, such as the one presented in Japanese Patent No.2998072, rolled it in order with a four-stage rolling mill, and cut it into a dough sheet of approx. 950×1895×5.3 mm. We dried the dough sheet in a roller hearth kiln and then burnt it. Gradually raised temperature and burnt the sheet until the water absorption reached 2.5% to obtain test pieces of approx. 900×1800 mm. As a result Compounds Nos. II, V, VII, IX, X and XI (all of them manufactured with the present invention) were in a good product condition, while the rest of the test pieces, namely Compound No. I without talc, Compound No. III with 40% of talc by weight, Compound No. IV without vitrifying components, Compound No. V with 50% of vitrifying components by weight and Compound No. VIII without wollastonite were all in a bad condition. Incidentally, the graph charts presented in FIGS. 2, 3 and 4 show how water absorption of Compounds Nos. I˜XI changed, when the burning temperature was variably raised. One of these graphs shows that Compound No. VII which was added 5% of finely powdered feldspar with more than 10% of alkaline components in it, obtained water absorption of 2.5% at a temperature lower than 1078° Celsius, and that it is confirmed that a large-scale ceramic board can be made with it.

Moreover, the table in FIG. 5 shows physical properties of Compounds Nos. X and IV. Regarding Compound No. X processed with the present invention, its burning temperature was set at 1091° Celsius, and the test piece had thickness of 4.3 mm being in an excellent product condition. Also, if Compound No. IV is burnt at the same burning temperature, softening deformation will occur, so we researched its physical properties regarding the test piece burnt at a lowered temperature of 1070° Celsius, where it can maintain its shape. According to this, Compound No. X processed with the present invention had a lower absorption of 2.5% and excellent frost-resistance, but showed high bending strength of 48N/mm². Besides, it had specific gravity of 2.2, which means that it is light, so that it is highly executable, and because of its shrinkage rate of 5.6%, it is comparatively easy to realize dimensional precision. On the other hand, the product of Compound No. IV had a high absorption of 12% and low frost-resistance, and further showed bending strength of 40N/mm², which is lower than that of the product processed with the present invention. Moreover, as we operated x-ray analysis on Compounds Nos. IV and X, it was confirmed that both of them had crystalline peaks of low wollastonite in them, though their strengths of crystalline peaks were different. According to this fact, Compound No. X which was processed with the present invention has low absorption of 2.5%, but the wollastonite has not had crystalline inversion, and still exists as in needle state (fibrous state), and so as a result presented the above-mentioned excellent physical properties.

And next, we paid attention to the relation between burning temperature and water absorption, that is to say, densification. When you observe the relation between burning temperature and water absorption regarding the above-mentioned Compound No. X, you will find that at two places, namely 1088° Celsius and 1098° Celsius, the graph line descends steeply showing that it is not in direct proportion (a straight line). The graph chart in FIG. 12 shows the relation between the absorption of Compound No. X (the horizontal axis) and the inclination (the vertical axis) of the graph line in FIG. 4 (the same one as that of Compound No. X presented in FIG. 9), wherein the line shows big curves as well, and thus it is presumed that the reaction progresses drastically in the above-mentioned temperature ranges. These temperature ranges are close to the crystal inversion temperature of wollastonite, and therefore, it is to be regarded that internal energy of the reaction was excited, so that its reactivity was raised. And this reactivity is closely related to the particle size (surface area), that is, the larger the surface area is, the higher the reactivity is; thus, we measured the particle size (length) distribution of the utilized wollastonite, and the result was as in the table of FIG. 6. Thus, it is regarded that at 1088° Celsius mainly particles of shorter than 125 μm are reactive, and at 1098° Celsius particles of 150 μm˜250 μm.

Incidentally, we added glass powder to Motoyama-Kibushi clay and low wollastonite which had been adopted in the sample experiment, wherein the combination was glass powder 35% by weight, Motoyama-Kibushi clay 40% by weight, low wollastonite 25% by weight, and then, after rolled it into a dough sheet similarly, we dehydrated and sintered it to get a comparative sample of a different combination. The burning temperature of this comparative sample was 1080° Celsius, its shrinkage rate was 5.1%, and its absorption was 3.4%. However, this product suffered from dehydration cracks and duntings. Meanwhile, we practiced x-ray analysis, peaks of cristobalite were observed. Though by utilizing glass powder it is possible to sinter at a lower temperature, it is presumed that under the influence of the reactivity of glass powder non-crystalline silica in liquid phase inverted to cristobalite. And it is regarded that the existance of this cristobalite causes a sharp variation in thermal expansion around 200° Celsius, which leads to a decrease in thermal shock resistance as well as a development of duntings, and consequently it is safe to say that it is difficult to produce a large-scale thin ceramic board utilizing glass powder. On the other hand, it is considered that owing to eutectic operation, the present invention decreases the sintering temperature and maintains the fibrous situation of the low wollastonite, so that generated liquid phase including a plenty of crystalline phase moderates thermal shock and makes the production of large-scale thin ceramic boards possible.

### EXPERIMENT SAMPLE 2

Thus next, we graded grains of low wollastonite combining the long-fiber type and the short-fiber type which had been used in Compound No. X, and tried to stabilize its reaction. As the table in FIG. 7, we prepared two kinds of short-fiber wollastonites (A) and (B), combined them according to the ratios described in FIG. 8 (Compounds Nos. XII, XIII and XIV), mixed and kneaded them as in the sample experiment 1, and made them into bodies. And in the same way, we extruded the bodies using a de-airing pug-mill, then rolled them through a four-stage rolling mill one by one, made them into dough sheets of the same size as mentioned above, and after dehydration and burning we gained test pieces in the size of approximately 900×1800 mm. These did not have any cracks, nor duntings as in the case of Compound No. X, and almost no warpage could be found, thus the external appearances of the products were excellent. FIG. 9 shows changing relations between burning temperatures and water absorptions. According to this graph chart, the relation between burning temperature and water absorption of Compound No. XII was close to approximate direct proportion, while the low wollastonite which has undergone grading of grains with short fibers can achieve water absorption of 3% or less at a lower burning temperature, compared to the one which has only long fibers (Compound No. X). This means that utilizing short-fiber wollastonite, compounds can be burnt at a lower temperature than the crystal inversion temperature, and that it is possible to produce stable ceramic boards without crystal inversion. Furthermore, FIG. 12 shows the relations between absorptions regarding Compounds Nos. X, XII, XIII and XIV (the horizontal axis) and inclinations of the graph lines (the vertical axis) presented in FIG. 9, where the lines of Compounds Nos. XII and XIII indicate changes closer to a straight line, thus meaning stable reactions. And also, regarding Compound No. XIV into which only short-fiber type was combined, there is a tendency that the burning temperature becomes lower, owing to its particle sizes, but it is observed that its reactivity is not controlled similar to the one into which only long fibers were combined (Compound No. X). And further, the table in FIG. 10 shows physical values of Compounds Nos. X and XII of which absorption was set to be 2.5%. From this result it was made clear that though it has a lower burning temperature, Compound No. XII has the same physical values as Compound No. X with a higher burning temperature, and this fact led to a decrease of burning temperature. Moreover, the table in FIG. 11 shows the results of comparison, where in the direction of 1800 mm sides, that is longer sides of the boards of Compounds Nos. X and XII, their dimensional differences between right and left were compared, and according to the table, it is observed that Compound No. X has a dimensional difference of 4.0 mm, while Compound No. XII has a difference of no more than 1.4 mm. As a result of this, it is presumed that as far as wollastonite with grain grading is concerned, a good balance of particle size could be achieved and its stability was increased.

### BRIEF DESCRIPTIONS ON FIGURES

FIG. 1 is a table showing the combination and the product condition of Compounds Nos. I˜XI.

FIG. 2 is a graph chart showing the relations between water absorptions and burning temperatures of Compounds Nos. I˜III.

FIG. 3 is a graph chart showing the relations between water absorptions and burning temperatures of Compounds Nos. IV˜VII.

FIG. 4 is a graph chart showing the relations between water absorptions and burning temperatures of Compounds Nos. VIII˜XI.

FIG. 5 is a table showing physical values of Compounds Nos. IV and X.

FIG. 6 is a table showing particle size distribution of low wollastonite.

FIG. 7 is a table showing particle size distribution of long- and short-fiber wollastonites.

FIG. 8 is a table showing combinations of Compounds Nos. X, XII˜XIV.

FIG. 9 is a graph chart showing the relations between water absorptions and burning temperatures of Compounds Nos. X, XII˜XIV.

FIG. 10 is a table showing physical values of the burnt products of Compounds Nos. XII and X.

FIG. 11 is a table showing dimensional differences between right and left sides of Compounds Nos. XII and X.

FIG. 12 is a graph chart showing the relations between absorptions (the horizontal axis) regarding Compounds Nos. X, XII, XIII and XIV and inclinations of the graph lines (the vertical axis) presented in FIG. 9.

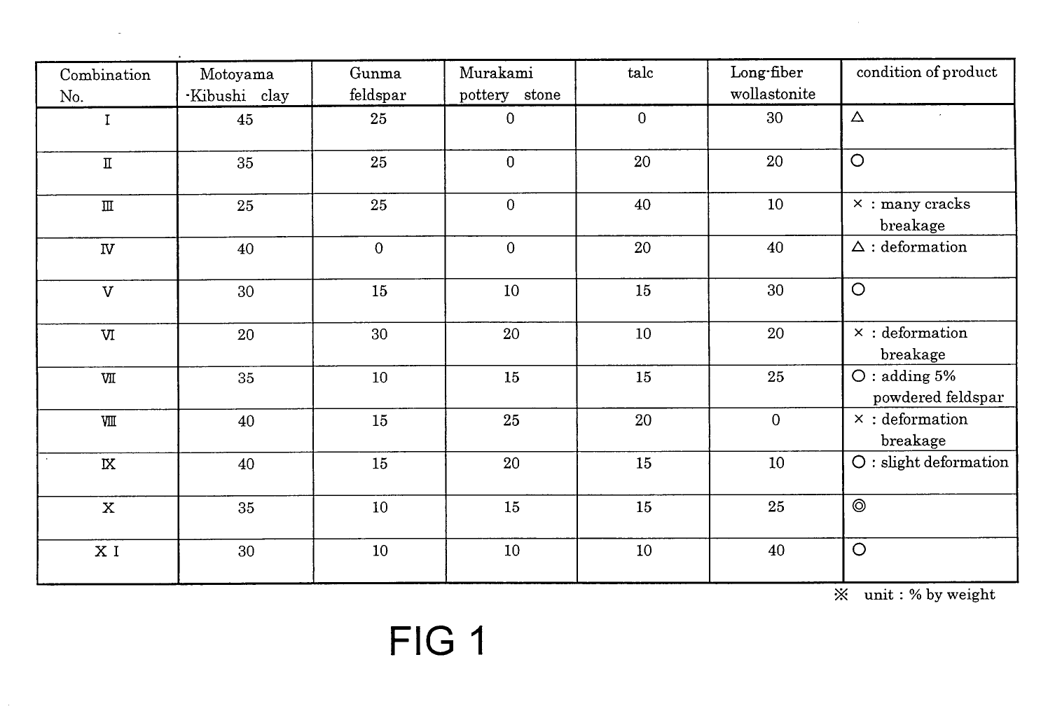

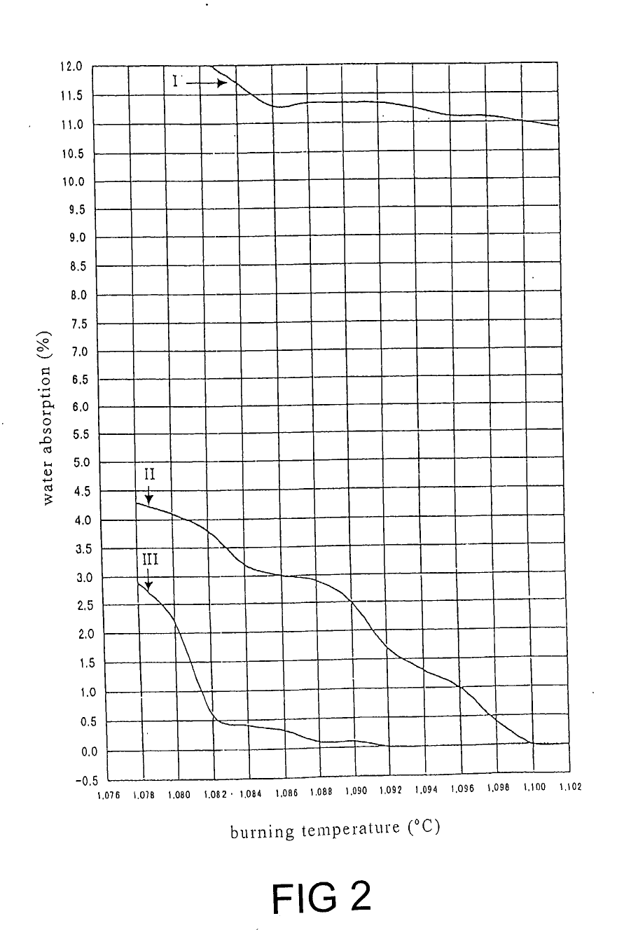

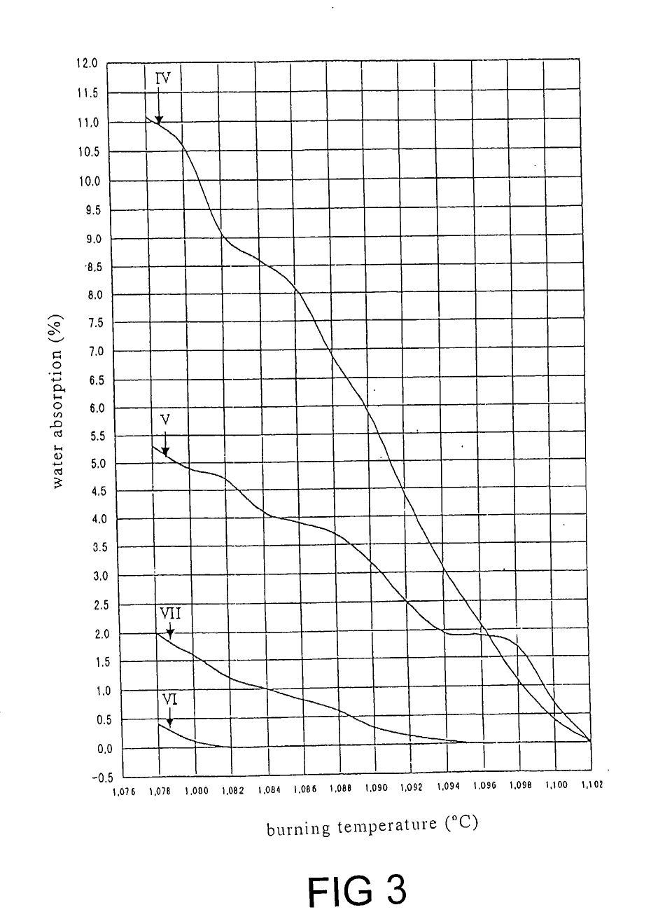

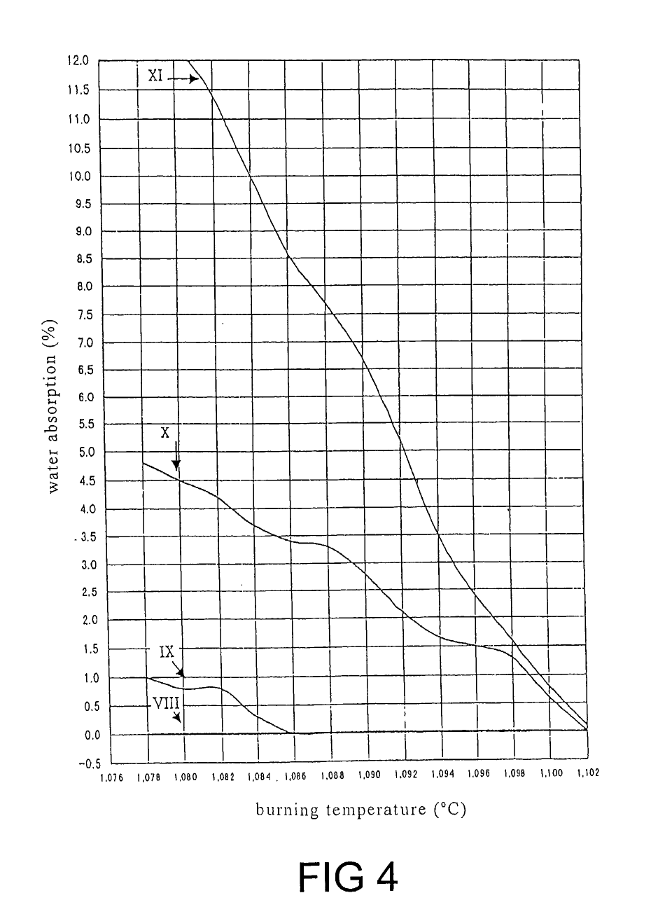

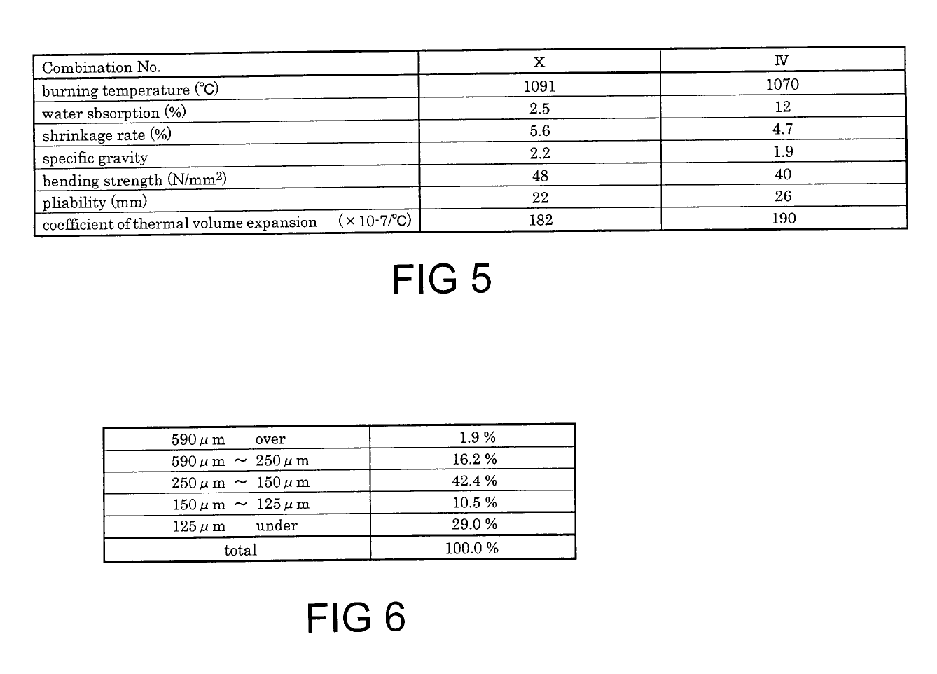

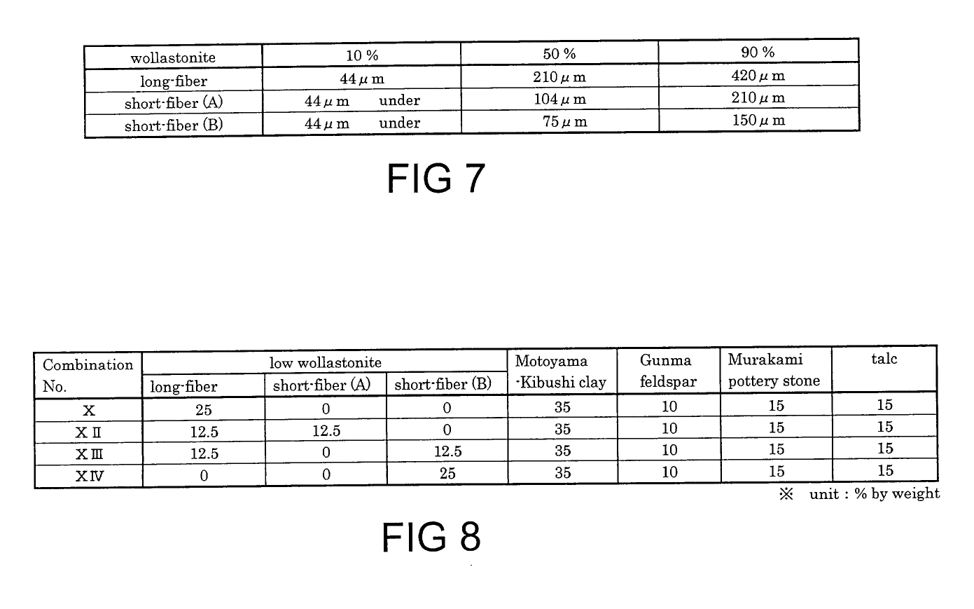

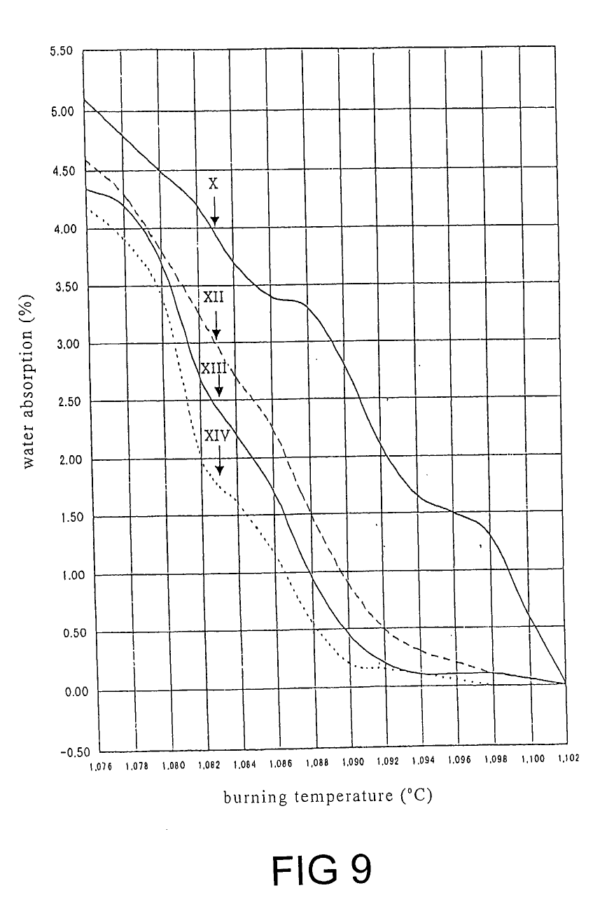

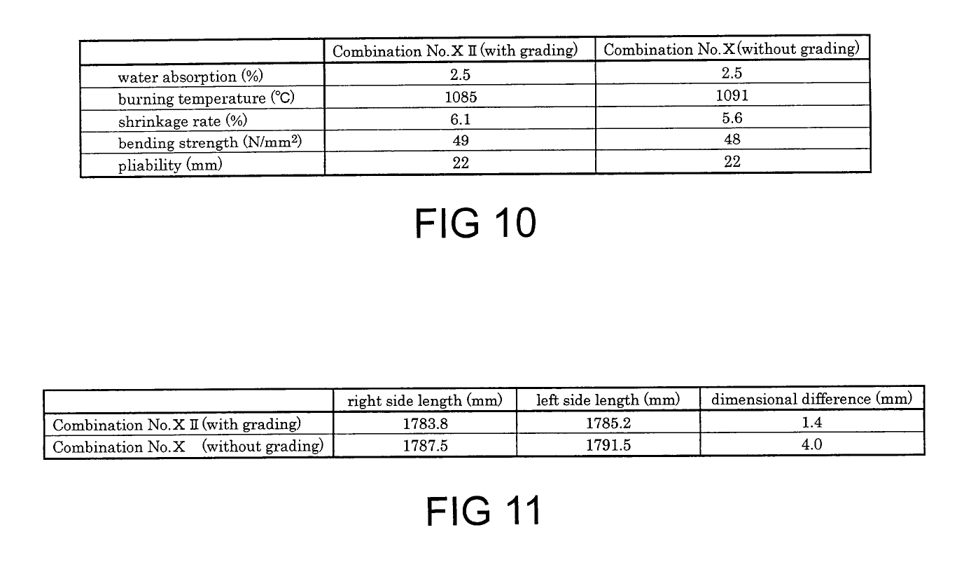

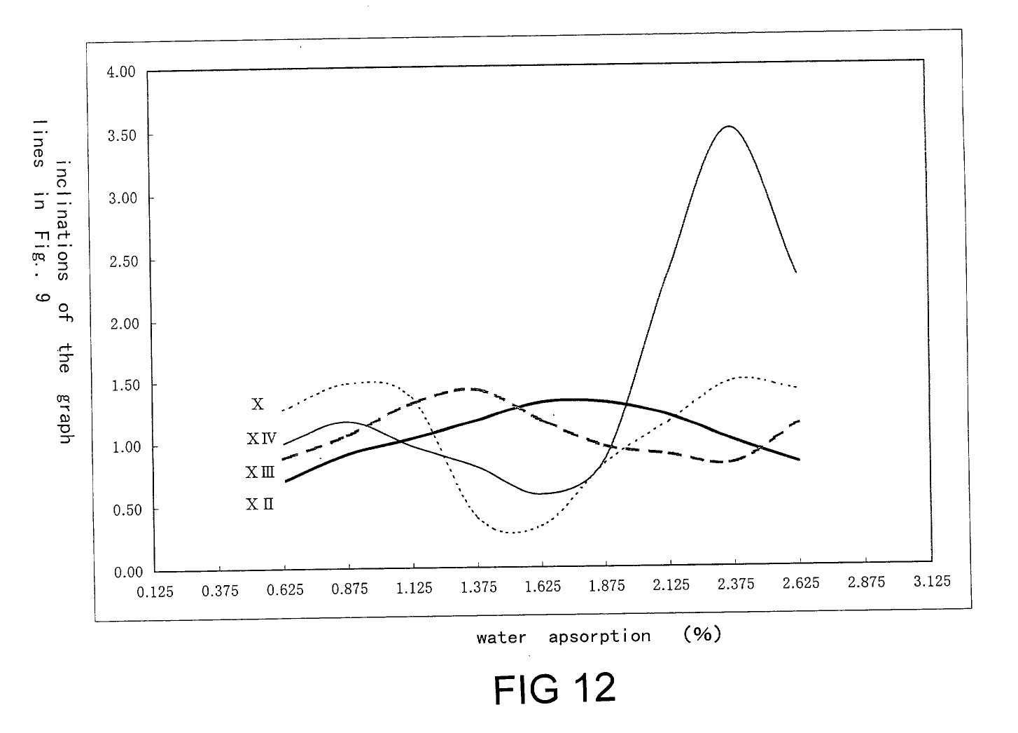

What is claimed is:

1. A thin board of sintered product featuring low water absorption, manufactured through containing principal ingredients such as talc, vitrifying components, low wollastonite which is needle crystal mineral, and plastic clay; compacting them into a thin board with the low wollastonite oriented and aligned uniformly in one preferred direction; and then burning it at a temperature lower than the crystal inversion temperature of low wollastonite.

2. The manufacturing method of the thin board of sintered product featuring low water absorption, manufactured through containing principal ingredients such as talc, vitrifying components, low wollastonite which is needle crystal mineral, and plastic clay; mixing, kneading and compacting them into a thin board with the low wollastonite oriented and aligned uniformly in one preferred direction; and then burning it at a temperature lower than the crystal inversion temperature of low wollastonite.

3. The thin board of sintered product featuring water absorption of 3% or less, and its manufacturing method as claimed in claims 1 and 2.

4. The thin board of sintered product featuring the composition of talc in an amount of approx 5˜30%, vitrifying components in an amount of approx. 10˜40%, low wollasonite in an amount of approx. 10˜40%, and plastic clay in an amount of approx. 20˜50% each by weight; and its manufacturing method as claimed in claims 1, 2 and 3.

5. The thin board of sinterd product featuring its component low wollastonite as a mixture of long-fiber type and short-fiber type; and its manufaturing method as claimed in claims 1, 2, 3 and 4.
